(19) United States
(12) Patent Application Publication
(10) Pub. No.: US 2013/0287979 A1
(43) Pub. Date: Oct. 31, 2013

(54) BIODEGRADABLE THERMOPLASTIC COMPOSITIONS

(71) Applicants: Joao Carlos Girioli, Campinas (BR); Derval do Santos Rosa, Campinas (BR); Paulo Aparecido dos Santos, Vinhedo (BR)

(72) Inventors: Joao Carlos Girioli, Campinas (BR); Derval do Santos Rosa, Campinas (BR); Paulo Aparecido dos Santos, Vinhedo (BR)

(73) Assignee: SABIC INNOVATIVE PLASTICS IP B.V., Bergen op Zoom (NL)

(21) Appl. No.: 13/457,146

(22) Filed: Apr. 26, 2012

(51) Int. Cl. C08K 5/098; B32B 1/02; B29C 45/17; C08L 67/04

(52) U.S. Cl. 428/35.7; 523/124; 264/328.17

(57) ABSTRACT

A biodegradable thermoplastic composition includes about 10 to about 80 wt. % of poly(3-hydroxybutyrate); about 10 to about 80 wt. % of a copolymer, wherein the copolymer comprises polypropylene units and poly(3-hydroxibutyrate) units; about 0.5 to about 10 wt. % of a compatibilizer; and about 0.2 to about 10 wt. % of a pro-degradation additive, wherein the pro-degradation additive comprises a transition metal stearate; and wherein the weight percents are based on the total weight of the biodegradable thermoplastic composition. These compositions comply with global standards regarding biodegradable materials and can be used in a wide array of applications, such as cosmetic containers, cell phones, laptops and packaging applications.

### BACKGROUND

This disclosure relates to thermoplastic compositions and in particular to biodegradable thermoplastic compositions. This disclosure also relates to methods of manufacturing these compositions and articles that include these compositions.

Plastic articles do not degrade for many years. Plastic articles in today's society contribute to many problems such as litter, waste of valuable landfill space and entombment of waste. The detrimental effects of synthetic polymers on the environment have become increasingly evident in recent decades, mainly because of the resistance of these materials to peroxidation and to degradation by water and microorganisms. Biodegradable polymers can offer a substantially reduced impact on the environment, effectively creating a closed-loop life cycle, and mitigating the aforementioned shortcomings of petroleum-based plastic articles.

Biodegradable polymers provide a strategy to overcome the stresses on fossil fuel resources, the carbon footprint and the global environment. The biodegradation of polymers involves well-documented mechanisms, which can vary depending on the particular chemistry of the polymer. The reduced life cycle of biodegradable polymers make them ideal candidates for single-use disposable articles.

Within the industry, there are a wide variety of known biodegradable polymers, of which the aliphatic polyester group has gained an increasing global interest. Among the aliphatic polyesters, polyhydroxyalkanoates (PHA) present good mechanical properties, and compatibility with many types of polymers. Discovered in 1925, PHAs have been documented in more than 100 different forms in recent years. Within that array, polyhydroxybutyrate (PHB) and derivatives thereof have been at the forefront of academia. PHB is a natural, linear, homochiral, thermoplastic polyester produced by microorganism metabolism of intracellular fat deposits in response to limited nutrient availability. Once extracted, the PHB solidifies and demonstrates mechanical properties analogous to those of polypropylene (PP). Other notable properties include: (1) better oxygen barrier performance than polypropylene and polyethylene terephthalate (PET), (2) lower water barrier performance than PP and (3) good resistance to solubility in water.

The degradation of PHB depends on the microbial activity of the environment and on the surface area of the sample. In addition, the crystallinity, molecular weight of the sample, and temperature are important factors that influence the growth of microorganisms on the polymer surface.

However, PHB also includes two important property deficiencies, thermal instability and brittleness, that have been identified and that need to be overcome before PHB can be utilized as a commercial product.

Accordingly, it would be beneficial to provide a biodegradable thermoplastic material that offers improved thermal stability and/or flexibility. It would also be beneficial to provide a biodegradable article that includes a biodegradable thermoplastic material that offers improved thermal stability and/or flexibility. It would be further beneficial to provide a method of making a biodegradable thermoplastic material that offers improved thermal stability and/or flexibility.

### SUMMARY

This disclosure provides a biodegradable thermoplastic composition having improved thermal stability and/or flexibility. The compositions include a polyhydroxybutyrate polyester, a polypropylene-polyhydroxybutyrate copolymer, a compatibilizer; and a pro-degradation additive. These compositions are biodegradable based on global standards and are used in a variety of commercial articles, such as, for example, cosmetic containers, cellphones, laptops, and packaging applications.

Disclosed herein is a thermoplastic composition comprising about 10 to about 80 wt. % of poly(3-hydroxybutyrate); about 10 to about 80 wt. % of a copolymer, wherein the copolymer comprises polypropylene units and poly(3-hydroxybutyrate) units; about 0.5 to about 10 wt. % of a compatibilizer; and about 0.2 to about 10 wt. % of a pro-degradation additive; where the weight percents (wt. % s) are based on the total weight of the thermoplastic composition.

Disclosed herein is a method of forming a thermoplastic composition comprising blending about 10 to about 80 wt. % of poly(3-hydroxybutyrate); about 10 to about 80 wt. % of a copolymer, wherein the copolymer comprises polypropylene units and poly(3-hydroxybutyrate) units; about 0.5 to about 10 wt. % of a compatibilizer; and about 0.2 to about 10 wt. % of a pro-degradation additive; where the weight percents (wt. % s) are based on the total weight of the thermoplastic composition.

Disclosed herein too are articles manufactured from the thermoplastic composition.

### DETAILED DESCRIPTION

As used in the specification and in the claims, the term “comprising” can include the embodiments “consisting of” and “consisting essentially of.” All ranges disclosed herein are inclusive of the endpoints and are independently combinable. The endpoints of the ranges and any values disclosed herein are not limited to the precise range or value; they are sufficiently imprecise to include values approximating these ranges and/or values.

The interest in and the development of polymeric biodegradable materials has grown considerably in recent years on a global scale and has generated vast technological evolution in the field of biodegradable materials. However, the high production cost of biodegradable materials, in comparison with other commercially available plastics, combined with the challenges concerning thermal stability and flexibility associated with polyhydroxybutyrate (PHB), have presented a barrier for many manufacturers. Consequently, focus has been placed on generating biodegradable materials at a low cost in order to facilitate market penetration. A blend of a biodegradable polymer with a low-cost polymer which also exhibits thermal stability and mechanical flexibility would therefore provide an advantage both in terms of cost and environmental impact.

Accordingly, disclosed herein is a biodegradable thermoplastic composition comprising a polyhydroxybutyrate polyester, a copolymer comprising polypropylene and polyhydroxybutyrate, a compatibilizer and a pro-degradation additive, wherein the resulting compositions comply with global standards for biodegradable materials. The compositions display improved thermal stability and/or mechanical properties, e.g., flexibility, relative to PHB homopolymer. As such, the compositions are manufactured by means of a continuous process such as extrusion and are capable of being molded into articles using a commercially available molding process, such as injection molding.

This copolymer comprising polypropylene units and polyhydroxybutyrate units facilitates an improved thermal stability and/or mechanical flexibility to the biodegradable thermoplastic composition, thereby helping remediate some of the deficiencies of using only the biodegradable PHB homopolymer. The copolymer also facilitates improved compatibility, or miscibility, with the biodegradable PHB homopolymer. The use of a compatibilizer and a prodegradation additive helps form a biodegradable thermoplastic composition capable of being formed by extrusion and/or used in an injection molding process while also helping to promote degradation of the copolymer such that the biodegradable thermoplastic composition complies with global standards for biodegradable materials.

Accordingly, in an embodiment, the biodegradable thermoplastic composition comprises a polyhydroxybutyrate polyester. Polyhydroxybutyrate is a species of the polyhydroxyalkanoate (PHA) chemical class of molecules. PHAs are linear molecules produced in nature by bacterial fermentation of sugar or lipids. The monomers of PHAs include 3-hydroxyalkanoates. An alkanoate is a linear fatty acid molecule that comprises carbon and hydrogen (an alkane) with a carboxyl group at one end (making an alkanoate). In an embodiment, these monomers have a hydroxyl group (OH) at the 3rd carbon (also referred to as the beta position), making these beta or 3-hydroxyalkanoates. The hydroxyl group of one monomer is attached to the carboxyl group of another by an ester bond; thus, the plastics in this embodiment are polyesters. The polyester linkage creates a molecule which has 3-carbon segments separated by oxygen atoms. The remainder of the monomer becomes a side chain off the main backbone of the polymer.

PHB is a thermoplastic material, with melting a point (Tₘ) of about 170° C. to about 185° C. and a glass transition temperature (T_{q}) of about 5° C. The most common type of PHAs encountered in nature are poly(3-hydroxybutyrate), in which the monomer unit is hydroxybutyric acid and the side chain is a methyl group. PHB has properties similar to those of polypropylene (PP); however, it is stiffer and more brittle. PHB biodegrades in microbially active environments in about 5 to about 6 weeks. The action of some enzymes produced by microbes solubilizes PHB and is then absorbed through the cell wall and metabolized. PHB is normally broken down into carbon dioxide and water when degraded in aerobic conditions. In the absence of oxygen, the degradation is faster, and methane is also produced.

An example of a PHB homopolymer for use in the thermoplastic compositions is poly(3-hydroxybutyrate) (P3HB) homopolymer, or a combination including P3HB homopolymer. The P3HB homopolymer can be an oligomer or a polymer (i.e., having a molecular weight greater than or equal to about 10,000 grams per mole). In an exemplary embodiment, the PHB homopolymer is a P3HB homopolymer. The chemical structure for P3HB is provided below in formula (I), where “n” is an integer of about 1 to about 20,000.

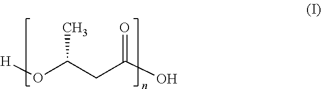

The amount of the PHB homopolymer used in the thermoplastic compositions is based on the selected properties of the thermoplastic composition. Other factors include the amount and/or type of the copolymer used, the amount and/or type of compatibilizer used, the amount and/or type of pro-degradation additive used, the type of molded article to be formed and/or the presence of any other additives or fillers.

In an embodiment, the PHB homopolymer is present in an amount of from about 10 to about 80 wt. %, specifically about 20 to about 70 wt %, and more specifically about 30 to about 60 wt %, of the biodegradable thermoplastic composition. In an exemplary embodiment, the PHB is present in an amount of from about 20 to about 60 wt. %, specifically about 30 to about 50 wt. %, more specifically about 35 to about 45 wt. %, and even more specifically, about 38 to about 43 wt. % of the biodegradable thermoplastic composition. In another embodiment, the PHB homopolymer has a number average molecular weight (Mn) of at least about 3,000 to about 200,000 grams per mole.

The use of PHB homopolymer has a direct effect on the physical properties of the thermoplastic composition. PHB homopolymer, with its short methyl side chain, is a crystalline and brittle polymer. Industrially, it is difficult to use because PHB homopolymer melts at approximately about 170° C. to about 185° C., but begins to thermally degrade in the vicinity of the melting temperature (Tₘ), thus, making melt processing difficult. Once thermal cleavage of the polymer chains is initiated, mechanical properties are reduced. In addition, PHB homopolymer has an elongation at break that is about 5 to about 8%, which is only 1/7.5 and 1/20 of that of polypropylene (PP) or polyethylene terephthalate (PET), respectively. Presumably, though not wishing to be bound by theory, brittleness is caused by low nucleation density that arises from the PHB homopolymer's high purity. Thus, cracks can form in the large diameter, high volume spherulites, and cause the plastic to break. Accordingly, the biodegradable thermoplastic compositions blend the PHB homopolymers, or more specifically, the P3HB homopolymers, with another polymer that possesses the selected thermal stability and/or mechanical flexibility such that desirable properties can be attained.

Accordingly, in addition to the PHB homopolymer, the moldable and biodegradable thermoplastic compositions also include a copolymer. As used herein, the term “copolymer” (also referred to as a heteropolymer) generally refers to a polymer derived from two (or more) monomeric species or structural units. In contrast, a “homopolymer” uses only one monomer. The copolymer can be an alternating copolymer, a periodic copolymer, a statistical (or random) copolymer, a block copolymer, an alternating block copolymer, a random block copolymer, a linear copolymer, a branched copolymer such as a star (or radial) copolymer and a graft copolymer, a dendrimer, or the like, or a combination comprising at least one of the foregoing copolymers. The copolymer comprises polyhydroxybutyrate (PHB) units and polypropylene (PP) units. In an exemplary embodiment, the copolymer comprises poly(3-hydroxybutyrate) (P3HB) units and polypropylene units.

The PP-PHB copolymer is provided to help improve thermal stability and/or mechanical properties, such as flexibility, of the thermoplastic composition, thereby helping to alleviate the problems associated with biodegradable materials such as PHB homopolymer or other polyhydroxyalkanoates. By using a PP-PHB copolymer in conjunction with the PHB homopolymer, the thermoplastic compositions display improved thermal stability and/or mechanical flexibility while also being biodegradable based on global standard ASTM D 6003. The copolymer also provides improved compatibility, or miscibility, with the biodegradable PHB homopolymer.

The relative amounts of PP and PHB in the copolymer used in the thermoplastic compositions are based on the selected properties of the thermoplastic compositions. Other factors include the amount and/or type of the copolymer used, the amount and/or type of compatibilizer used, the amount and/or type of pro-degradation additive used, the type of molded article to be formed and/or the presence of any other additives or fillers.

In an embodiment, the PHB homopolymer unit is present in the copolymer in an amount from about 20 wt. % to about 80 wt. %, specifically from about 30 wt. % to about 70 wt. %, even more specifically from about 40 wt. % to about 60 wt. % of the total weight of the copolymer. In another embodiment, the PP unit is present in the copolymer in an amount from about 20 wt. % to about 80 wt. %, specifically from about 30 wt. % to about 70 wt. %, even more specifically from about 40 wt. % to about 60 wt. % of the total weight of the copolymer. In an exemplary embodiment, PP is present in an amount of about 50 wt. % of the copolymer and PHB is present in an amount of about 50 wt. % of the copolymer.

The amount of the PP-PHB copolymer added to the biodegradable thermoplastic compositions can be based on the desired properties of the thermoplastic compositions. Other factors include the amount and/or type of the PHB homopolymer used, the compatibilizer used, the pro-degradation additive used, the type of molded article to be formed and/or the presence of any other additives or fillers. In an embodiment, the PP-PHB copolymer is present in an amount of from about 10 to about 80 wt. %, specifically about 20 to about 70 wt. %, specifically about 30 to about 60 wt. %, specifically about 40 to about 60 wt. % and more specifically about 50 to about 60 wt. % of the total weight of the biodegradable thermoplastic composition. The PP-PHB copolymer can be formed using any known method for blending components to form a copolymer. Examples of blending processes are described further herein with respect to forming the thermoplastic compositions.

In addition to the PHB and the PP-PHB copolymer, the biodegradable thermoplastic compositions also include a compatibilizer. The addition of the compatibilizer helps to enable the PHB and the PP-PHB copolymer to generate effective blend miscibility and to form a composition that is capable of being formed into an article that is useful for being used as or incorporated into a commercial product.

Examples of compatibilizers include, ethylene methyl acrylate (EMA), maleic anhydride or a combination comprising at least one of the foregoing compatibilizers. In an exemplary embodiment, the compatibilizer is polypropylene grafted maleic anhydride (PPg-MAR).

The amount of compatibilizer used in the biodegradable thermoplastic composition is dependent on one more factors including, but not limited to, the type and amount of the PHB homopolymer used, the amount of the PP-PHB copolymer used, and the presence of any other additives or fillers. In an embodiment, the amount of compatibilizer added is from about 0.5 to about 10 wt. %, specifically about 1 to about 8 wt. %, and more specifically about 2 to about 6 wt. %, of the total weight of the biodegradable thermoplastic composition. In one exemplary embodiment, the compatibilizer EMA and/or the compatibilizer PPg-MAH is present in an amount of from about 1 to about 6 wt. %, specifically about 2 to about 5 wt. %, even more specifically about 2 to about 4 wt. % of the total weight of the biodegradable thermoplastic composition. Although maleic anhydride has generally been considered to not be comparable to methyl acrylate for use as a compatibilizer for thermoplastic compositions comprising a blend of PHB homopolymer and PP homopolymer, as discussed in the results below, PP-g-MAH is an example of a compatibilizer used in the thermoplastic compositions herein.

The biodegradable thermoplastic composition also includes a pro-degradation additive. The pro-degradation additive helps enhance the degradation of the copolymer, or more specifically, the polypropylene contained in the PP-PHB copolymer. As such, the resulting biodegradable thermoplastic compositions comply with global standards regarding biodegradable materials. The pro-degradation additive helps facilitate initiation of oxy-degradation in which the PP-PHB copolymer chains are systematically reduced in size as a result of free radical cleavage. While the pro-degradation additive alone will not render the final composition biodegradable, the use of the pro-degradation additive helps to biodegrade the PP-PHB copolymer while the PHB homopolymer biodegrades without the use of the additive such that the overall composition is considered biodegradable.

Examples of pro-degradation additives include a transition metal stearate or a combination comprising a transition metal stearate. In an exemplary embodiment, the pro-degradation additive is manganese stearate.

The amount of pro-degradation additive used in the biodegradable thermoplastic composition is dependent on one more factors including the type and amount of PP-PHB copolymer used, the type of molded article to be formed and/or the presence of any other additives or fillers. In an embodiment, the amount of pro-degradation additive is from about 0.2 to about 10 wt. %, specifically about 0.5 to about 5 wt. %, and more specifically about 0.8 to about 3 wt. % of the total weight of the biodegradable thermoplastic composition. In an exemplary embodiment, the pro-degradation additive is manganese stearate and is present in an amount of from about 0.5 to about 3 wt. %, specifically about 0.5 to about 2 wt. %, even more specifically about 0.8 to about 1.2 wt. % of the total weight of the biodegradable thermoplastic composition.

In addition to the PHB homopolymer, the PP-PHB copolymer, the compatibilizer and the pro-degradation additive, the biodegradable thermoplastic compositions can include various additives ordinarily incorporated in resin compositions of this type. Mixtures of additives can be used. Such additives can be mixed in during the mixing of the components for forming the composition. The one or more additives are included in the biodegradable thermoplastic compositions to impart one or more selected characteristics to the biodegradable thermoplastic compositions and any molded article made therefrom. Examples of additives that can be included in the biodegradable thermoplastic compositions include, but are not limited to, heat stabilizers, process stabilizers, antioxidants, light stabilizers, plasticizers, antistatic agents, mold releasing agents, UV absorbers, lubricants, pigments, dyes, colorants, flow promoters, or a combination comprising at least one of the foregoing additives.

Examples of heat stabilizers include, for example, organo phosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations including at least one of the foregoing heat stabilizers. Heat stabilizers are generally used in amounts of from about 0.01 to about 0.50 parts by weight based on 100 parts by weight of the biodegradable thermoplastic composition, excluding any filler.

Examples of antioxidants include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis [methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tort-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tertbutyl-4-hydroxyphenyl)propionate or the like; amides of beta-(3,5-di-tert-butyl-4-hydroxyphenyl)-propionic acid or the like, or combinations including at least one of the foregoing antioxidants. Antioxidants are generally used in amounts of from about 0.01 to 0.50 parts by weight, based on 100 parts by weight of the total biodegradable thermoplastic composition, excluding any filler.

Examples of light stabilizers include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone or the like or combinations including at least one of the foregoing light stabilizers. Light stabilizers are generally used in amounts of from about 0.1 to about 1.0 parts by weight, based on 100 parts by weight of the biodegradable thermoplastic composition, excluding any filler.

Examples of plasticizers include, for example, phthalic acid esters such as dioctyl-4,5-epoxy-hexahydrophthalate, tris-(octoxycarbonylethyl)isocyanurate, tristearin, epoxidized soybean oil or the like, or combinations including at least one of the foregoing plasticizers. Plasticizers are generally used in amounts of from about 0.5 to about 3.0 parts by weight, based on 100 parts by weight of the total biodegradable thermoplastic composition, excluding any filler.

Examples of antistatic agents include, for example, glycerol monostearate, sodium stearyl sulfonate, sodium dodecylbenzenesulfonate or the like, or combinations of the foregoing antistatic agents. In an embodiment, carbon fibers, carbon nanofibers, carbon nanotubes, carbon black, or any combination of the foregoing or a combination including at least one of the foregoing can be used in a polymeric resin containing chemical antistatic agents to render the biodegradable thermoplastic composition electrostatically dissipative.

Examples of mold releasing agents include for example, metal stearate, stearyl stearate, pentaerythritol tetrastearate, beeswax, montan wax, paraffin wax, or the like, or combinations including at least one of the foregoing mold release agents. Mold releasing agents are generally used in amounts of from about 0.1 to about 1.0 parts by weight, based on 100 parts by weight of the total biodegradable thermoplastic composition, excluding any filler.

Examples of UV absorbers include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(414-3,1-benzoxazin-4-one) (CYASORB™ UV-3638); 1,3-bis[(2-cyano-3,3-diphenylacryloyl)oxy]-2,2-bis[[(2-cyano-3,3-diphenylacryloyl)oxy]methyl]propane (UVINUL™ 3030); 2,2′-(1,4-phenylene)bis(4H-3,1-benzoxazin-4-one); 1,3-bis[(2-cyano-3,3diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than 100 nanometers; or the like, or combinations including at least one of the foregoing UV absorbers. UV absorbers are generally used in amounts of from about 0.01 to about 3.00 parts by weight, based on 100 parts by weight based on 100 parts by weight of the total biodegradable thermoplastic composition, excluding any filler.

Examples of lubricants include for example, fatty acid esters such as alkyl stearyl esters, e.g., methyl stearate or the like; mixtures of methyl stearate and hydrophilic and hydrophobic surfactants including polyethylene glycol polymers, polypropylene glycol polymers, and copolymers thereof e.g., methyl stearate and polyethylene-polypropylene glycol copolymers in solvent; or a combination comprising at least one of the foregoing lubricants. Lubricants are generally used in amounts of from about 0.1 to about 5.0 parts by weight, based on 100 parts by weight of the total biodegradable thermoplastic composition, excluding any filler.

Examples of pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates; sulfates and chromates; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow/147 and Pigment Yellow 150, or a combination comprising at least one of the foregoing pigments. Pigments are generally used in amounts of from about 1 to about 10 parts by weight, based on 100 parts by weight of the total biodegradable thermoplastic composition, excluding any filler.

Examples of dyes include, for example, organic dyes such as coumarin 460 (blue), coumarin 6 (green), nile red or the like; lanthanide complexes; hydrocarbon and substituted hydrocarbon dyes; polycyclic aromatic hydrocarbons; scintillation dyes (preferably oxazoles and oxadiazoles); aryl- or heteroaryl-substituted poly (2-8 olefins); carbocyanine dyes; phthalocyanine dyes and pigments; oxazine dyes; carbostyryl dyes; porphyrin dyes; acridine dyes; anthraquinone dyes; arylmethane dyes; azo dyes; diazonium dyes; nitro dyes; quinone imine dyes; tetrazolium dyes; thiazole dyes; perylene dyes, perinone dyes; bis-benzoxazolylthiophene (BBOT); and xanthene dyes; fluorophores such as anti-stokes shift dyes which absorb in the near infrared wavelength and emit in the visible wavelength, or the like; luminescent dyes such as 5-amino-9-diethyliminobenzo(a)phenoxazonium perchlorate; 7-amino-4-methylcarbostyryl; 7-amino-4-methylcoumarin; 3-(2′-benzimidazolyl)-7-N,N-diethylaminocoumarin; 3-(2′-benzothiazolyl)-7-diethylaminocoumarin; 2-(4biphenyl)-5-(4-t-butylphenyl)-1,3,4-oxadiazole; 2-(4biphenyl)-6-phenylbenzoxazole-1,3; 2,5-Bis-(4-biphenyl)l)-1,3,4-oxadiazole; 2,5-bis-(4-biphenyl)-oxazole; 4,4′-bis(2-butyloctyloxy)-p-quaterphenyl; p-bis(o-methylstyryl)benzene; 5,9-diaminobenzo(a)phenoxazonium perchlorate; 4-dicy anomethy lene-2-methyl-6-(p-dimethy lamino styry 1)4H-pyran; 1,1′-diethyl-2,2′-carbocyanine iodide; 3,3′-diethyl-4,4′,5,5′-dibenzothiatricarbocyanine iodide; 7-diethylamino-4-methy lcoumarin; 7-diethy lamino-45trifluoromethylcoumarin; 2,2′-dimethyl-p-quaterphenyl; 2,2-dimethy 1-p-terpheny 1; 7-ethyl amino-6-methyl-4trifluoromethylcoumarin; 7-ethy lamino-4 trifluoromethylcoumarin; nile red; rhodamine 700; oxazine 750; rhodamine 800; IR 125; IR 144; IR 140; IR 132; IR 26; IRS; diphenylhexatriene; diphenylbutadiene; tetraphenylbutadiene; naphthalene; anthracene; 9,10-diphenylanthracene; pyrene; chrysene; rubrene; coronene; phenanthrene or the like, or a combination comprising at least one of the foregoing dyes. Dyes are generally used in amounts of from about 0.1 to about 5.0 parts by weight, based on 100 parts by weight of the total biodegradable thermoplastic composition, excluding any filler.

Examples of colorants include, for example titanium dioxide, anthraquinones, perylenes, perinones, indanthrones, quinacridones, xanthenes, oxazines, oxazolines, thioxanthenes, indigoids, thioindigoids, naphthalimides, cyanines, xanthenes, methines, lactones, coumarins, bis-benzoxazolylthiophene (BBOT), naphthalenetetracarboxylic derivatives, monoazo and diazo pigments, triarylmethanes, aminoketones, bis(styryl)biphenyl derivatives, and the like, as well as combinations including at least one of the foregoing colorants. Colorants are generally used in amounts of from about 0.1 to about 5.0 parts by weight, based on 100 parts by weight of the total biodegradable thermoplastic composition, excluding any filler.

Examples of blowing agents include for example, low boiling halohydrocarbons and those that generate carbon dioxide; blowing agents that are solid at room temperature and when heated to temperatures higher than their decomposition temperature, generate gases such as nitrogen, carbon dioxide, ammonia gas, such as azodicarbonamide, metal salts of azodicarbonamide, 4,4′ oxybis(benzenesulfonylhydrazide), sodium bicarbonate, ammonium carbonate, or the like, or combinations including at least one of the foregoing blowing agents. Blowing agents are generally used in amounts of from about 1 to about 20 parts by weight, based on 100 parts by weight of the total biodegradable thermoplastic composition, excluding any filler.

Additionally, materials to improve flow and other properties can be added to the composition, such as low molecular weight hydrocarbon resins. Particularly useful classes of low molecular weight hydrocarbon resins are those derived from petroleum C5 to C9 feedstock that are derived from unsaturated C5 to C9 monomers obtained from petroleum cracking. Non-limiting examples include olefins, e.g., pentenes, hexenes, heptenes, or the like; diolefins, e.g., pentadienes, hexadienes, or the like; cyclic olefins and diolefins, e.g., cyclopentene, cyclopentadiene, cyclohexane, cyclohexadiene, methyl cyclopentadiene, or the like; cyclic diolefin dienes, e.g., dicyclopentadiene, methylcyclopentadiene dimer, or the like; and aromatic hydrocarbons, e.g., vinyltoluenes, indenes, methylindenes, or the like. The resins can additionally be partially or fully hydrogenated.

The PP-PHB copolymer, and the thermoplastic compositions comprising the PP-PHB copolymer, PHB homopolymer, compatibilizer and pro-degradation additive, and any other additives(s) that can be used, can be combined using any known method of combining multiple components to form a thermoplastic resin. The copolymer can be formed prior to forming the rest of the thermoplastic composition. The preparation of the thermoplastic composition can be achieved by blending the ingredients under conditions that produce an intimate blend. All of the ingredients can be added initially to the processing system, or else certain additives can be precompounded with one or more of the primary components. The PP-PHB copolymer, and the PP-PHB copolymer together with the PHB homopolymer, compatibilizer, pro-degradation additive and any other additives that can be used, can generally be combined in several different ways such as, dry blending, melt blending, solution blending, or the like, or combinations comprising at least one of the foregoing methods of blending. In an embodiment, the components are first dry blended in a high-speed mixer such as a Henschel mixer or Waring blender. Other low shear processes including, but not limited to, hand mixing can also accomplish this blending. The blend is then fed into the throat of a twin-screw extruder, where the mixture is melt blended via a hopper. Alternatively, one or more of the components can be incorporated into the composition by feeding directly into the extruder at the throat and/or downstream through a sidestuffer. The extruder is generally operated at a temperature higher than that necessary to cause the composition to flow. The extrudate is immediately quenched in a water batch and pelletized. The pellets so prepared when cutting the extrudate can be one-fourth inch long or less as desired. Such pellets can be used for subsequent molding, shaping, or forming.

Blending involves the use of shear force, extensional force, compressive force, ultrasonic energy, electromagnetic energy, thermal energy or combinations comprising at least one of the foregoing forces or forms of energy and is conducted in processing equipment wherein the aforementioned forces or forms of energy are exerted by a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, or combinations comprising at least one of the foregoing.

Melt blending involving the aforementioned forces can be conducted in machines such as single or multiple screw extruders, Buss kneader, Henschel mixer, helicones, Ross mixer, Banbury, roll mills, molding machines such as injection molding machines, vacuum forming machines, blow molding machine, or the like, or combinations comprising at least one of the foregoing machines.

In an embodiment, the PP-PHB copolymer and the PHB homopolymer, in powder form, pellet form, sheet form, or the like, can be first dry blended with the compatibilizer and pro-degradation additive in a Henschel mixer or in a roll mill, prior to being fed into a melt blending device such as an extruder or Buss kneader. It can be desirable to introduce the PP-PHB copolymer, compatibilizer, pro-degradation additive, or a combination of the PP-PHB copolymer, compatibilizer and pro-degradation additive into the melt blending device in the form of a masterbatch. In such a process, the masterbatch can be introduced into the melt blending device downstream of the point where the PHB homopolymer is introduced.

In another embodiment, a portion of the PP-PHB copolymer can be pre-mixed with the PHB homopolymer to form a dry preblend. The dry preblend is then melt blended with the remainder of the PP-PHB copolymer in an extruder. In another embodiment, some of the PP-PHB copolymer can be fed initially at the mouth of the extruder while the remaining portion of the PP-PHB copolymer is fed through a port downstream of the mouth.

A melt blend is one where at least a portion of the PP-PHB copolymer has reached a temperature greater than or equal to about the melting temperature, if the resin is a semi-crystalline organic polymer, or the flow point (e.g., the glass transition temperature) if the resin is an amorphous resin during the blending process. A dry blend is one where the entire mass of copolymer is at a temperature less than or equal to about the melting temperature if the resin is a semi-crystalline copolymer, or at a temperature less than or equal to the flow point if the copolymer is an amorphous resin and wherein organic polymer is substantially free of any liquid-like fluid during the blending process. A solution blend, as defined herein, is one where the copolymer is suspended in a liquid-like fluid such as, for example, a solvent or a non-solvent during the blending process.

The moldable composition comprising the PP-PHB copolymer, PHB homopolymer, compatibilizer and pro-degradation additive can be subject to multiple blending and forming steps if desirable. For example, the moldable composition can first be extruded and formed into pellets. The pellets can then be fed into a molding machine where it can be formed into any desirable shape or product. Alternatively, the moldable composition emanating from a single melt blender can be formed into sheets or strands and subjected to post-extrusion processes such as annealing, uniaxial or biaxial orientation.

Solution blending can also be used to manufacture the thermoplastic composition. Solution blending can also use additional energy such as shear, compression, ultrasonic vibration, or the like, to promote homogenization of the PHB homopolymer, compatibilizer and pro-degradation additive with the PP-PHB copolymer. In an embodiment, a PP-PHB copolymer suspended in a fluid can be introduced into an ultrasonic sonicator along with the PHB homopolymer, compatibilizer and pro-degradation additive. The mixture can be solution blended by sonication for a time period effective to disperse the PHB homopolymer, compatibilizer and pro-degradation additive onto the PP-PHB copolymer particles. The PP-PHB copolymer along with the PHB homopolymer, compatibilizer and pro-degradation additive can then be dried, extruded and molded if desired. It is generally desirable for the fluid to swell the PP=PHB copolymer during the process of sonication. Swelling the PP-PHB copolymer generally improves the ability of the PHB homopolymer, compatibilizer and pro-degradation additive to impregnate the PP-PHB copolymer during the solution blending process and consequently improves dispersion.

Shaped, formed, or molded articles including the thermoplastic compositions are also provided. The thermoplastic compositions can be molded into useful shaped articles by a variety of means such as injection molding, extrusion, rotational molding, blow molding and thermoforming to form articles.

Examples of articles that can be made using the biodegradable thermoplastic composition include but are not limited to, injection-molded bottles, plastic films, cosmetic containers, cell phones, laptops, and packaging applications.

The invention is further illustrated by the following non-limiting examples.

### EXAMPLES

In these examples, the biodegradable polymer disclosed herein and comparative examples using a polypropylene homopolymer instead of a PP-PHB copolymer were prepared. In the embodiments, the polyhydroxyalkanoate polyester homopolymer was PHB homopolymer while the copolymer was PP-PHB.

### Example 1

In this example, 41.24 wt. % of a poly(3-hydroxybutyrate) homopolymer, 57.73 wt. % a polypropylene-poly(3-hydroxybutyrate) copolymer and 1.03 wt. % of manganese stearate were hand mixed before introduction into an extruder. No compatibilizer was used in this example.

### Example 2

In this example, 40.00 wt. % of a poly(3-hydroxybutyrate) homopolymer, 56.00 wt. % a polypropylene-poly(3-hydroxybutyrate) copolymer, 3.00 wt. % of PPg-MAH as a compatibilizer and 1.00 wt. % of manganese stearate were hand mixed before introduction into an extruder.

### Example 3

In this example, 40.00 wt. % of a poly(3-hydroxybutyrate) homopolymer, 56.00 wt. % a polypropylene-poly(3-hydroxybutyrate) copolymer, 3.00 wt. % of EMA as a compatibilizer and 1.00 wt. % of manganese stearate were hand mixed before introduction into an extruder.

### Example 4

In this example, 41.24 wt. % of a poly(3-hydroxybutyrate) homopolymer, 57.73 wt. % a polypropylene homopolymer, and 1.03 wt. % of manganese stearate were hand mixed before introduction into an extruder. No compatibilizer was used in this example.

### Example 5

In this example, 40.00 wt. % of a poly(3-hydroxybutyrate) homopolymer, 56.00 wt. % a polypropylene homopolymer, 3.00 wt. % of PPg-MAH as a compatibilizer and 1.00 wt. % of manganese stearate were hand mixed before introduction into an extruder.

### Example 6

In this example, 40.00 wt. % of a poly(3-hydroxybutyrate) homopolymer, 56.00 wt. % a polypropylene homopolymer, 3.00 wt. % of EMA as a compatibilizer and 1.00 wt. % of manganese stearate were hand mixed before introduction into an extruder.

Biodegradability of Examples 1-6 was determined based on tensile strength retention and per visual inspection, as measured according to ASTM D 6003. The tensile strength of specimens was measured according to ASTM D 638 and then the specimens were buried in simulated soil compost at room temperature (24° C.). The simulated soil consisted of 23% loamy silt, 23% organic matter (cow manure), 23% sand and 31% distilled water (all wt/wt). Biodegradation was monitored for 210 days by measuring the tensile strength retention approximately each 30 days. The buried specimens were recovered, washed with distilled water and dried at room temperature until there was no further variation in weight, after which they were evaluated for tensile strength. Additionally, the weight loss of the specimens were tracked along the burying time.

The thermal stability and mechanical properties of the blends in Examples 1-6 were evaluated according to ASTM standards and are shown in Table 2 below. Tensile strength was measured according to ASTM D 638. Tensile strain was measured according to ASTM D 638. Flexural strength was measured according to ASTM D 790. The heat deflection temperature (HDT) was measured according to ASTM D 648 at 1.8 MPa and 0.45 MPa, respectively.

TABLE 1

| Thermal/Mechanical Property | Ex. 1 | Ex. 2 | Ex. 3 | Ex. 4 | Ex. 5 | Ex. 6 |
|---|---|---|---|---|---|---|
| Tensile Strength (MPa) | 18 | 25 | 20 | 35 | 28 | 28 |
| Tensile Strain (%) | 9 | 13 | 13 | 8 | 7 | 8 |
| Flexural Strength (MPa) | 30 | 38 | 31 | 50 | 31 | 40 |
| Flexural Modulus (GPa) | 1.17 | 1.78 | 1.44 | 2.32 | 1.88 | 1.91 |
| HDT, 6.4 mm, 1.8 (MPa) | 58 | 64 | 61 | 67 | 65 | 68 |
| HDT, 6.4 mm, 0.45 (MPa) | 87 | 100 | 98 | 129 | 110 | 116 |

As demonstrated by the results shown in Table 1, when a PHB homopolymer was blended with a polypropylene homopolymer using EMA or PPg-MAH as a compatibilizer, the compositions in Examples 5 and 6 exhibited a loss in mechanical properties when compared to the same composition without the compatibilizer in Example 4. The loss of mechanical properties despite the presence of a compatibilizer demonstrates that there was no compatibilization between the PHB homopolymer and the PP homopolymer.

In contrast, when a PHB homopolymer was blended with a PP-PHB copolymer using EMA or PPg-MAH as a compatibilizer, the compositions in Examples 2 and 3 exhibited significantly improved mechanical properties when compared to the same composition without either compatibilizer in Example 1. The improvement in mechanical properties in the presence of a compatibilizer demonstrates that there was compatibilization between the PHB homopolymer and PP-PHB copolymer. In addition, the composition in Example 2, in which a PHB homopolymer, a PP-PHB copolymer, manganese stearate and a PPg-MAH compatibilizer were blended, demonstrated superior mechanical properties when compared to the same composition using EMA as a compatibilizer instead of PPg-MAH.

The terms “a” and “an” do not denote a limitation of quantity, but rather denote the presence of at least one of the referenced item.

The term “or” means “and/or.”

Reference throughout the specification to “an embodiment”, “one embodiment”, “another embodiment”, “an embodiment”, and so forth, means that a particular element (e.g., feature, structure, and/or characteristic) described in connection with the embodiment is included in at least one embodiment described herein, and can or can not be present in other embodiments. In addition, it is to be understood that the described elements can be combined in any suitable manner in the various embodiments.

In general, the compositions or methods can alternatively comprise, consist of, or consist essentially of, any appropriate components or steps herein disclosed. The invention can additionally, or alternatively, be formulated so as to be devoid, or substantially free, of any components, materials, ingredients, adjuvants, or species, or steps used in the prior art compositions or that are otherwise not necessary to the achievement of the function and/or objectives of the present claims.

“Optional” or “optionally” means that the subsequently described event or circumstance can or can not occur, and that the description includes instances where the event occurs and instances where it does not.

The modifier “about” used in connection with a quantity is inclusive of the stated value and has the meaning dictated by the context (e.g., includes the degree of error associated with measurement of the particular quantity).

The endpoints of all ranges directed to the same component or property are inclusive of the endpoints, are independently combinable, and include all intermediate points and ranges optional: [(e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” such as about 10 wt % to about 23 wt %, etc.).

The suffix “(s)” as used herein is intended to include both the singular and the plural of the term that it modifies, thereby including one or more of that term (e.g., the colorant(s) includes one or more colorants).

The term “combination” is inclusive of blends, mixtures, alloys, reaction products, and the like.

Unless defined otherwise, technical and scientific terms used herein have the same meaning as is commonly understood by one of skill in the art to which this invention belongs.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

While the invention has been described with reference to a preferred embodiment and various alternative embodiments, it will be understood by those skilled in the art that changes can be made and equivalents can be substituted for elements thereof without departing from the scope of invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A thermoplastic composition, comprising:
about 10 to about 80 wt. % of poly(3-hydroxybutyrate);
about 10 to about 80 wt. % of a copolymer, wherein the copolymer comprises polypropylene units and poly(3-hydroxybutyrate) units;
about 0.5 to about 10 wt. % of a compatibilizer; and
about 0.2 to about 10 wt. % of a pro-degradation additive, wherein the pro-degradation additive comprises a transition metal stearate; where the weight percents are based on the total weight of the thermoplastic composition.

2. The thermoplastic composition of claim 1, wherein the pro-degradation additive is manganese stearate.

3. The thermoplastic composition of claim 1, wherein the compatibilizer is a maleic anhydride grafted polyolefin.

4. The thermoplastic composition of claim 1, wherein the compatibilizer is propylene grafted maleic anhydride.

5. The thermoplastic composition of claim 1, wherein the compatibilizer is ethylene methyl acrylate.

6. The thermoplastic composition of claim 1, wherein the thermoplastic composition comprises about 35 to about 45 wt. % of poly(3-hydroxybutyrate).

7. The thermoplastic composition of claim 1, wherein the thermoplastic composition comprises about 45 to about 65 wt. % of the copolymer comprising polypropylene units and poly(3-hydroxybutyrate) units.

8. The thermoplastic composition of claim 1, wherein the thermoplastic composition comprises about 1 to about 4 wt. % of the compatibilizer.

9. The thermoplastic composition of claim 1, wherein the thermoplastic composition comprises about 0.2 to about 2 wt. % of the pro-degradation additive.

10. The thermoplastic composition of claim 1, wherein the copolymer is a linear copolymer, a graft copolymer, or a combination thereof.

11. The thermoplastic composition of claim 1, wherein the copolymer is a star block copolymer.

12. An article of manufacture comprising the thermoplastic composition of claim 1.

13. The article of manufacture of claim 12, wherein the article of manufacture is an injection-molded bottle, a plastic film, a cosmetic container, a cell phone, a laptop, or a package component.

14. A method of forming a thermoplastic composition comprising:
combining about 10 to about 80 wt. % of poly(3-hydroxybutyrate); about 10 to about 80 wt. % of a copolymer, wherein the copolymer comprises polypropylene units and poly(3-hydroxybutyrate) units; about 0.5 to about 10 wt. % of a compatibilizer; and about 0.2 to about 10 wt. % of a pro-degradation additive, wherein the pro-degradation additive comprises a transition metal stearate; and wherein the weight percents are based on the total weight of the thermoplastic composition.

15. The method of claim 14, further comprising molding the thermoplastic composition to form an article.

16. The method of claim 15, wherein the molding comprises injection molding.
